(19) United States
(12) Patent Application Publication
(10) Pub. No.: US 2023/0208137 A1
(43) Pub. Date: Jun. 29, 2023

(54) DEVICES AND METHODS FOR IMPROVING A GRID SYNCHRONIZATION OF UNIDIRECTIONAL POWER CONVERTERS

(71) Applicant: HUAWEI DIGITAL POWER TECHNOLOGIES CO., LTD., Shenzhen (CN)

(72) Inventor: Francisco Daniel FREIJEDO FERNÁNDEZ, Nuremberg (DE)

(21) Appl. No.: 18/177,975

(22) Filed: Mar. 3, 2023

Related U.S. Application Data
(63) Continuation of application No. PCT/EP2020/074740, filed on Sep. 4, 2020.

(51) Int. Cl. H02J 3/08; H02M 1/42; H02M 1/00

(52) U.S. Cl. CPC H02J 3/08; H02M 1/4208; H02M 1/0009; H02M 1/0087

(57) ABSTRACT

Example unity power factor converter, (UPFC) operating methods and apparatus are described. In one example, the UPFC comprises a closed-loop control for regulation of an input current from a power grid in accordance with a reference variable for the input current. The UPFC is configured to determine amplitudes of frequency components of the input current, and establish a phase angle of the reference variable in dependence of a phase angle of a fundamental frequency component of an input voltage from the power grid and of the amplitudes of the frequency components.

### CROSS-REFERENCE TO RELATED APPLICATIONS

This application is a continuation of International Application No. PCT/EP2020/074740, filed on Sep. 4, 2020, the disclosure of which is hereby incorporated by reference in its entirety.

### TECHNICAL FIELD

The present disclosure relates to synchronization of unity power factor converters (UPFCs) to an energizing power grid. The present disclosure provides, to this end, an UPFC, connectable to a power grid, wherein the UPFC comprises a closed-loop control for regulation of an input current from the power grid in accordance with a reference variable for the input current. The present disclosure also provides a method for operating the UPFC as a Solid State Transformer (SST).

### BACKGROUND

In alternate current (AC) high/medium voltage grids, interfaces between different voltage levels are typically formed by line-frequency transformers (LFTs). LFTs are cost effective, highly efficient at high loads, and reliable. However, they suffer from several limitations, including voltage drop under load, sensitivity to harmonics, load imbalances and direct current (DC) offsets, no overload protection, and low efficiency when operating with light loads.

SSTs represent a power electronics based alternative to LFTs. They are based on power electronics switches, sensors, and intelligent controls, which enable advanced functionalities such as power flow control, reactive power, harmonics, and imbalances compensation, smart protection and ride-through capabilities. Furthermore, a high-frequency switching operation enables a significant reduction of the volume and weight. Some of these features combined may make SST advantageous compared to classical LFTs.

At an interface with the AC power grid, SSTs may be implemented according to a Modular Multilevel topology composed by a plurality of cells. Such topologies may enable a bidirectional or a unidirectional power transfer.

Bidirectional topologies may be realized based on “four quadrant” cascaded H-bridge (CHB) modules, in which a turn on/off operation of four active power electronic switches (e.g., insulated-gate bipolar transistors (IGBTs) or metal oxide semiconductor field-effect transistors (MOSFETs)) per module adequately connects/disconnects the AC input to the DC output.

Unidirectional topologies further simplify the bidirectional modules by replacing part of the active power electronic switches with diodes.

In comparison to bidirectional SST topologies, unidirectional unity power factor SSTs have an important challenge related to grid synchronization: i.e., a current total harmonic distortion (THDi) is very sensitive to an accurate zero-crossing detection of the grid voltage. Several phenomena can be problematic in this context. Voltage phase angle estimation errors can be due to a) presence of voltage harmonics, b) weakness of the grid reflected in the acquired signal, c) uncompensated delays in the acquisition and control system, d) dead-time effects, and/or e) poor phase-locked loop (PLL) design/implementation/tuning. Furthermore, a strong physical constraint is that voltage and current must work with the same sign as imposed by the unidirectional physical system, or, in other words: current cannot reverse the voltage at any instant. So, when current aims to get reversed, this is not allowed by the circuit.

Especially a light load operation is very challenging, since it may result in multiple current zero-crossings. Zero-crossings may have a strong effect on a current waveform, and thus may give rise to non-linearity that creates distortion and instability.

### SUMMARY

In view of the above-mentioned problems and disadvantages, it is an object to improve a synchronization of unidirectional UPFCs to an energizing AC power grid.

This objective is achieved by the embodiments as defined by the appended independent claims. Further embodiments are set forth in the dependent claims and in the following description and drawings.

A first aspect of the present disclosure provides a UPFC connectable to a power grid. The UPFC comprises a closed-loop control for regulation of an input current from the power grid in accordance with a reference variable for the input current. The UPFC is configured to determine amplitudes of frequency components of the input current, and establish a phase angle of the reference variable in dependence of a phase angle of a fundamental frequency component of an input voltage from the power grid and of the amplitudes of the frequency components.

Thereby, a further dependency of the phase angle of the reference variable on the amplitudes of the frequency components is introduced, besides the known dependency of the phase angle of the reference variable on the phase angle of the fundamental frequency component of the input voltage from the power grid.

Thereby, the closed-loop current control may specifically revise the reference value of the phase angle of the input current from the power grid based on undesired harmonic frequency components of the input current.

Thereby, a synchronization of the UPFC to the power grid is improved.

The UPFC may further be configured to establish an amplitude of the reference variable in dependence of an outer closed-loop control of the UPFC.

Thereby, an electric power drawn from the power grid and regulated by an outer closed-loop control may define a target/reference value for regulation of the fundamental amplitude of the input current drawn from the power grid.

The UPFC may further be configured to establish the phase angle of the fundamental frequency component of an input voltage by a PLL of the UPFC when the PLL is locked onto the fundamental frequency component of the input voltage.

Thereby, a coarse tuning/regulation of a phase angle of the input current drawn from the power grid is achieved in dependence of the phase angle of the fundamental frequency component of the input voltage tracked by the PLL.

The UPFC may further be configured to establish the phase angle of the reference variable by adding up the phase angle of the fundamental frequency component of the input voltage and a phase correction angle determined in dependence of the amplitudes of the frequency components.

Thereby, the target/reference phase angle also takes into account the harmonic frequency components of the input current besides the fundamental frequency component of the input voltage, by means of a simple implementation.

The UPFC may further be configured to determine the phase correction angle in dependence of a custom total harmonic distortion (CTHDi) of the input current determined as a rational function in dependence of the amplitudes of the frequency components.

Thereby, the closed-loop current control is enabled to respond to any harmonic frequency components of the regulated input current by considering a single quantity rather than multiple frequency components.

Thereby, a fine tuning/regulation of the phase angle of the input current drawn from the power grid is achieved in dependence of the CTHDi and further in dependence of the amplitudes of the frequency components of the input current.

The UPFC may further be configured to determine the phase correction angle by means of Extremum Seeking Control (ESC).

Thereby, the closed-loop current control itself is regulated by ESC according to the deterministic relation between the CTHDi, i.e., the harmonic frequency components of the input current, and the phase correction angle. This ensures a more accurate tuning/regulation of the phase angle of the input current as compared to mere tracking of the phase angle of the fundamental frequency component of the input voltage by the PLL.

The CTHDi may comprise an oscillation.

The oscillation perturbs the closed-loop current control and thus allows for gradient estimation of its control behavior. Thereby, the closed-loop current control is systematically analysed in terms of its deterministic response to the perturbation in accordance with ESC theory.

A frequency of the oscillation may be less than a nominal frequency of the power grid.

The perturbation/oscillation frequency controls time scale separation of an estimation process of the phase correction angle and the estimation process of the gradient performed by the inclusion of the perturbation/oscillation. Thereby, a—faster—regulation by the closed-loop current control and a—slower—regulation by ESC do not interfere with each other owing to operation on different time scales/time constants. Thus, a slow but highly effective phase angle correction is achieved, which decouples the zero-crossing distortion compensation from the main control loops (e.g., power and current control). This also simplifies a development of control, which is of particular relevance when considering multi-module implementations.

The UPFC may further be configured to determine the amplitudes of the frequency components by a discrete Fourier transform, DFT, and/or fast Fourier transform, FFT.

The UPFC may further be configured to determine the amplitudes of the frequency components in real-time.

The amplitudes of the frequency components may comprise real-time Fourier coefficients, squared real-time Fourier coefficients, or a weighted rational combination of the real-time Fourier coefficients of the input current.

Thereby, the closed-loop current control is enabled to respond to any harmonic frequency components of the regulated input current as they arise, with no significant contribution to the dominant time constant of the closed-loop current control (from basic control theory, this dominant time constant can be evaluated during a step change in the current reference).

The UPFC may further be configured to manipulate a pulse-width modulation (PWM) drive signal for an active power electronic switching device of the UPFC.

Thereby, the power electronic switching device of the UPFC may realize a response to the corrected phase angle of the reference variable without requiring further modifications of its drive arrangement.

A second aspect of the present disclosure provides a method of operating a unity power factor rectifier, UPFC, connectable to a power grid. The UPFC comprises a closed-loop control for regulation of an input current from the power grid in accordance with a reference variable for the input current. The method comprises determining amplitudes of frequency components of the input current, and establishing a phase angle of the reference variable in dependence of a phase angle of a fundamental frequency component of an input voltage from the power grid and of the amplitudes of the frequency components.

The method may be performed by the UPFC according to the first aspect or any of its embodiments.

Thereby, the advantages mentioned in connection with the various embodiments of the UPFC of the first aspect apply similarly to the corresponding embodiments of the method according to the second aspect. The same applies to the embodiments of the third and fourth aspect, which respectively relate to the method according to the second aspect.

A third aspect of the present disclosure provides a computer program comprising a program code for carrying out the method according to the second aspect or any of its embodiments.

A fourth aspect of the present disclosure provides a non-transitory storage medium storing executable program code which, when executed by a processor, causes the method according to the second aspect or any of its embodiments to be performed.

It has to be noted that all devices, elements, units and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof.

### BRIEF DESCRIPTION OF DRAWINGS

The above described aspects will be explained in the following description of various embodiments in relation to the enclosed drawings, in which

FIG. 1 illustrates an exemplary SST topology;

FIG. 2 illustrates an exemplary closed-loop current control of an UPFC;

FIGS. 3, 4 illustrate a deficiency of the closed-loop control of FIG. 2 with respect to power grid synchronization;

FIG. 5 illustrates a closed-loop current control of an UPFC according to an embodiment of the first aspect;

FIGS. 6, 7 illustrate an improvement of the closed-loop control of FIG. 5 over exemplary solutions; and

FIG. 8 illustrates a method of operating a UPFC according to an embodiment of the first aspect.

### DETAILED DESCRIPTION OF EMBODIMENTS

The above described aspects will now be described with respect to various embodiments illustrated in the enclosed drawings.

The features of these embodiments may be combined with each other unless specified otherwise.

The drawings are to be regarded as being schematic representations and elements illustrated in the drawings are not necessarily shown to scale. Rather, the various elements are represented such that their function and general purpose become apparent to a person skilled in the art.

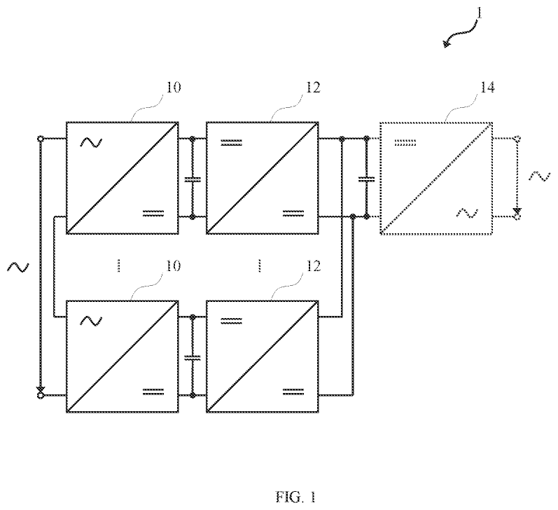

FIG. 1 illustrates an exemplary solid-state transformer, SST 1, topology.

Although the exemplary SST 1 topology of FIG. 1 is designed for energization by a single AC phase, those skilled in the art will appreciate that straightforward replication of the depicted topology for additional AC phases is possible.

An SST as used herein may comprise a switched AC/AC converter performing a switching operating at a frequency higher than a nominal grid frequency and may involve rectifier (AC/DC), converter (DC/DC) and inverter (DC/AC) stages.

The exemplary SST 1 of FIG. 1 draws AC power from its input port on the left-hand side of FIG. 1, provides DC power to a DC bus and optionally supplies transformed AC power to its output port on the right-hand side.

Between the input and output ports, the SST 1 implementation of FIG. 1 comprises rectifier 10 and DC/DC converter 12 stages. An optional inverter 14 stage is also indicated by dotted lines. Those skilled in the art will appreciate that different SST implementations may be envisaged as well.

The AC/DC conversion 10 stage is formed according to a Modular Multilevel topology, in which multiple modular cells 10, 12 are provided per phase, so that an electric power under transformation spreads across the multiple cells.

In the particular example of FIG. 1, the multiple modular cells 10, 12 of the rectifier 10 and the DC/DC converter 12 stages are interconnected in accordance with an input serial/output parallel (ISOP) topology. In other words, the input ports of the rectifier modules 10 are connected in series, and the output ports of the DC/DC converter modules 12 are connected in parallel to the DC bus. The optional inverter 14 may be regarded as a DC load connected to the common DC bus.

The rectifier modules 10 of the SST 1 directly interface with the energizing AC power grid. The rectifier modules 10 therefore are subject to statutory and/or contractual requirements as regards power factor correction (PFC). Rectifier modules 10 may have PFC functionality, and given an especially high power factor of (or very close to) 1 they are known as unity power factor correction rectifiers (UPFRs) or more broadly UPFCs.

A power factor as used herein refers to a ratio of real power to apparent power (fundamental component). A power factor of less than one indicates that voltage and current are not in phase.

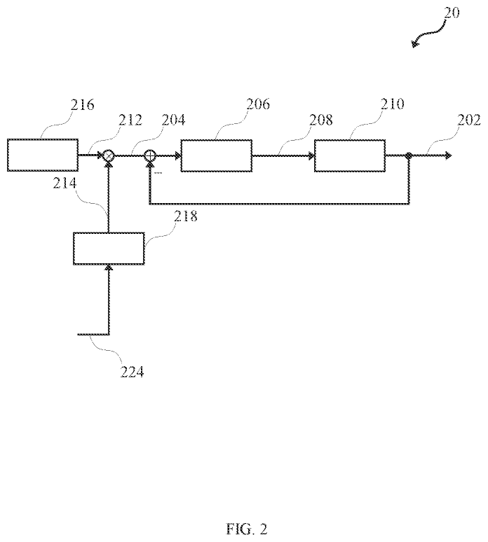

FIG. 2 illustrates an exemplary closed-loop current control 20 of an UPFC 10.

A closed-loop control as used herein refers to an arrangement, in which a process/system is regulated by a controller having a requisite corrective behavior. A feedback loop ensures that the controller exerts a control action to manipulate a process variable to be the same as a reference variable.

A closed-loop current control as used herein refers to closed-loop control of a current control process.

The closed-loop current control 20 comprises a controller 206 and a current control process 210. At the input of the controller 206, a control error is formed by subtracting a process variable (actual/measured current) 202 from a reference variable (reference current) 204, and the control error is turned into a manipulated variable 208, which may be a duty cycle 208 of a PWM drive signal for active power electronic switches (e.g., IGBTs or power MOSFETs) of the UPFC 10. The active power electronic switches thus are part of the current control process 210, which continuously yields the process variable (actual current) 202 produced in accordance with the manipulated variable (duty cycle) 208 to further minimize the control error.

PWM as used herein refers to a particular drive mode of the active power electronic switches involving a turn on/off operation, in this case to attain a PFC function.

An IGBT is a power semiconductor device appropriate for high voltage, high current and high switching frequency operations.

A power MOSFET is a power semiconductor device suitable for low voltage, medium current and very high switching frequency operations.

According to FIG. 2, the reference variable 204 comprises amplitude (or magnitude) 212 and phase angle 214 components. In other words, the reference variable 204 may be regarded as a complex number having amplitude (or magnitude) and phase (or phase angle) components.

As shown in FIG. 2, the UPFC 10 is configured to establish the amplitude 212 of the reference variable 204 in dependence of an outer closed-loop control 216 of the UPFC 10.

With continuing reference to FIG. 2, the UPFC 10 is configured to establish the phase angle 214 of the reference variable 204 in dependence of a phase angle θ, denoted as 224, of a fundamental frequency component of an input voltage from the power grid. In turn, the UPFC 10 is further configured to establish the phase angle 224 of the fundamental frequency component of the input voltage by a PLL 218 of the UPFC 10 when the PLL 218 is locked onto the fundamental frequency component of the input voltage.

A fundamental frequency component (or fundamental) as used herein refers to a lowest frequency of a periodic waveform. In terms of a superposition of sinusoids, the fundamental frequency is the lowest frequency sinusoidal in the sum. The fundamental frequency component is one of the harmonics.

A harmonic frequency component (or harmonic) as used herein refers to a frequency of a periodic waveform that is a positive integer multiple of the fundamental (i.e., that is a member of the harmonic series). In electric power systems, harmonics are voltages or currents at a multiple of the fundamental frequency of the system that are caused by non-linear loads such as rectifiers or saturated magnetic devices.

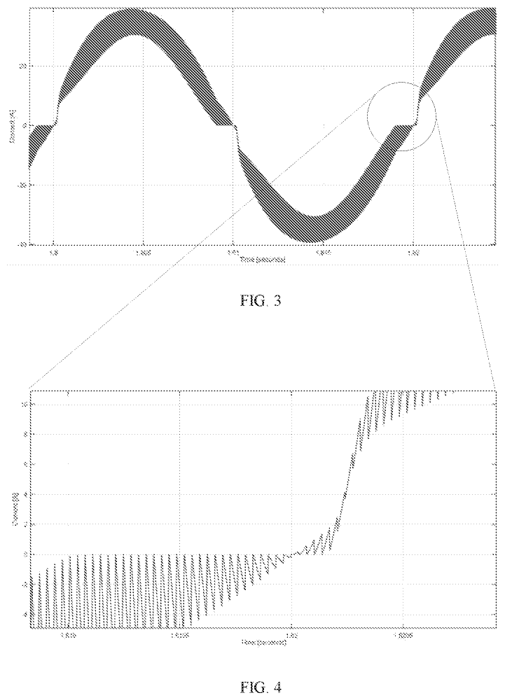

FIGS. 3, 4 illustrate a deficiency of the exemplary closed-loop control 20 of FIG. 2 with respect to power grid synchronization.

FIG. 3 shows a current waveform of a rectifier module 10 having a unidirectional topology, wherein the current waveform is impaired by sub-optimal operation in a vicinity of voltage zero-crossings. The horizontal and vertical axes of FIG. 3 represent time in seconds and current in amperes, respectively.

In such topologies, current cannot reverse the voltage at any instant. Thus, an inaccurate phase angle detection may result in a divergence of voltage and current waveforms, and when current aims to get reverse, this may not be allowed by the circuit.

FIG. 4 shows a zoom of a current zero-crossing of the current waveform of FIG. 3 around a voltage zero-crossing at time instant 1,62s. The figure exhibits a discontinuous conduction mode (DCM) operation in a vicinity of the voltage zero-crossing until voltage and current work with the same sign as imposed by the physical system. The DCM operation starts at time instant 1,619 s in a negative cycle of the input voltage (i.e., left of the voltage zero-crossing at time instant 1,62 s.) when the input current aims to become positive but cannot reverse the negative input voltage, and persists until the voltage zero-crossing at time instant 1,62 s initiates a positive cycle of the input voltage.

This effect is reflected as an increase in current distortion and can be quantified by the amplitudes of low order odd harmonics.

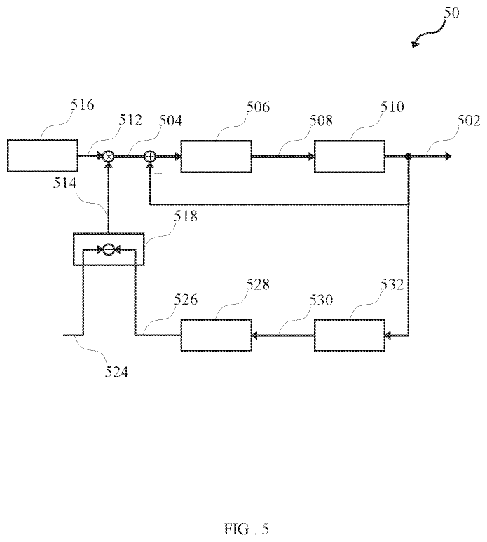

FIG. 5 illustrates a closed-loop current control 50 of a UPFC 10, according to an embodiment of the disclosure.

The UPFC 10 is connectable to a power grid. The closed-loop control 50 of the UPFC 10 is for regulation of an input current 502 from the power grid in accordance with a reference variable 504 for the input current 502.

The elements 502-516 of the closed-loop current control 50 respectively correspond in design, function and/or purpose to the corresponding elements 202-216 of the exemplary closed-loop current control 20 of FIG. 2.

According to FIG. 5, the reference variable 504 comprises amplitude (or magnitude) 512 and phase angle 514 components such that it may be regarded as a complex number.

Thereby, the closed-loop current control 50 may specifically revise the reference value of the phase angle of the input current 502 from the power grid based on undesired harmonic frequency components of the input current 502.

On the one hand, the UPFC 10 may be configured to establish the amplitude 512 of the reference variable 504 in dependence of an outer closed-loop control 516 of the UPFC 10.

Thereby, an electric power drawn from the power grid and regulated by the outer closed-loop control 516 may define a target/reference value for regulation of an amplitude of the input current 502 drawn from the power grid.

On the other hand, the UPFC 10 may be configured to determine amplitudes Iₙ of frequency components of the input current 502, and establish the phase angle 514 of the reference variable 504 in dependence of a phase angle θ, denoted as 524, of a fundamental frequency component of an input voltage from the power grid and of the amplitudes Iₙ of the frequency components.

Thereby, a further dependency of the phase angle 514 of the reference variable 504 on the amplitudes Iₙ of the frequency components is introduced, besides the known dependency of the phase angle 514 of the reference variable 504 on the phase angle 524 of the fundamental frequency component of the input voltage from the power grid. This is a consequence of the finding that the higher the phase angle error, the bigger the current harmonic distortion.

In accordance with the known dependency, the UPFC 10 may be configured to establish the phase angle 524 of the fundamental frequency component of the input voltage by a PLL 518 of the UPFC 10 when the PLL 518 is locked onto the fundamental frequency component of the input voltage.

Thereby, a target/reference value for coarse-tuning/regulation of a phase angle of the input current 502 drawn from the power grid is defined in dependence of the phase angle 524 of the fundamental frequency component of the input voltage tracked by the PLL 518.

A PLL as used herein refers to a control arrangement that generates an oscillating output signal having a phase angle that is related to the phase angle of an oscillating input signal. In other words, the phases of the input and output signals are locked.

The further dependency is reflected by a further feedback branch of the closed-loop control 50 of FIG. 5 starting at the process variable 502 and terminating at the PLL 518 of the UPFC 10. A signal processing along this feedback branch may work as follows:

A first control block 532 may be provided in the further feedback branch, which may be configured to perform time-frequency transforms. Based on this functionality, the UPFC 10 may further be configured to determine the amplitudes Iₙ of the frequency components by a DFT, and/or FFT and/or to determine the amplitudes Iₙ of the frequency components in real-time. As such, the amplitudes Iₙ of the frequency components may comprise real-time Fourier coefficients, squared real-time Fourier coefficients, or a weighted rational combination of the real-time Fourier coefficients of the input current 502.

Thereby, the closed-loop current control 50 is enabled to respond to any harmonic frequency components of the regulated input current 502 as they arise, with no significant contribution to the time constant of the closed-loop current control 50.

As an example, real-time Fourier coefficients may be obtained based on signal processing with a 100 Hz window, i.e. every 1/100 s(econd).

The first control block 532 may further be configured to perform total harmonic distortion calculations. Based on this functionality, the UPFC 10 may further be configured to determine a custom total harmonic distortion, CTHDi 530, of the input current 502 as a rational function in dependence of the amplitudes Iₙ of the frequency components.

Thereby, the closed-loop current control 50 is enabled to respond to any harmonic frequency components of the regulated input current 502 by considering a single quantity rather than multiple frequency components.

As such, the CTHDi 530 quantifies a current harmonic distortion.

In particular, the CTHDi 530 may be defined as an arbitrary rational function of (amplitudes of) low order harmonic frequency components, defined as Iₙ(t), with n being the order of the harmonic (1,2,3, etc.). One example for a simple definition of the CTHDi 530 is:

$$CTHDi ( t ) = 100 \sqrt{\frac{{I}_{3} ( t ) + {I}_{5} ( t ) + {I}_{7} ( t )}{{I}_{1} ( t )}}$$

A THD is a figure of merit of oscillation purity, and as used herein refers to a ratio of a sum of (squared) effective/RMS amplitudes of all harmonic frequency components to a (squared) effective/RMS amplitude of a fundamental frequency component.

A current Total Harmonic Distortion, THDi, as used herein refers to a THD of a current, which may be defined as a rational function in dependence of the effective/RMS amplitudes Iₙ of the frequency components of the current.

A current Custom Total Harmonic Distortion, CTHDi, as used herein refers to a THDi which may follow an expedient custom definition, such as in dependence of a limited number of effective/RMS amplitudes Iₙ of frequency components of the current, which may be expedient for real-time time-frequency transforms.

Those skilled in the art will appreciate that the above-mentioned functionalities of the first control block 532 may equally be split into separate elements.

Subsequent to the first control block 532, a second control block 528 may be provided in the further feedback branch, which may be configured to perform phase correction angle calculations. Based on this functionality, the UPFC 10 may further be configured to determine a phase correction angle Δθ, denoted as 526, in dependence of the CTHDi 530 of the input current 502 provided by the first control block 532.

Thereby, a target/reference value for fine-tuning/regulation of the phase angle of the input current 502 drawn from the power grid is defined in dependence of the CTHDi 530 and further in dependence of the amplitudes Iₙ of the frequency components of the input current 502.

The second control block 528 and thus the UPFC 10 may further be configured to determine the phase correction angle 526 by means of ESC 528.

As used herein, ESC refers to a model-free real-time optimization technique which aims at finding a system input such that a system output (i.e., a steady-state performance) of the controlled system is held at an extremum point. ESC does not require a system model, but relies on the system to be deterministic, so that a particular system input generates a particular system output. By perturbation of the system input with a slow periodic signal (oscillation, dither) that is commonly chosen to be sinusoidal, derivatives of the system can be estimated, according to which the system input can be steered in the direction of the extremum.

Since it has been found that the CTHDi 530 (system output) is a deterministic function of the phase angle 514 of the reference variable 504, or more specifically, the phase correction angle 526 contributing to the the phase angle 514, it can be assumed that there exists a phase correction angle 526 that minimizes the CTHDi 530, and the ESC technique may be used for doing so.

From a viewpoint of a possible ESC embodiment, the CTHDi 530 and the phase correction angle 526 may be regarded as the system output and the system input of the controlled system, respectively. In other words, the ESC-controlled system comprises the entire closed-loop control 50 starting from the output of the second control block 528 and terminating at its input. So, ESC is used to find a phase correction angle 526 that minimizes the current distortion (i.e. the CTHDi 530).

Thereby, the closed-loop current control 50 itself is regulated by ESC according to the deterministic relation between the CTHDi 530, i.e., the harmonic frequency components of the input current 502, and the phase correction angle 526. This ensures a more accurate tuning/regulation of the phase angle of the input current 502 as compared to mere tracking of the phase angle 524 of the fundamental frequency component of the input voltage by the PLL 518.

In accordance with the perturbation of the system input mentioned above, the CTHDi 530 may comprise an oscillation. The oscillation perturbs the closed-loop current control 50 and thus allows for gradient estimation of its control behavior.

Thereby, the closed-loop current control is systematically analysed in terms of its deterministic response to the perturbation in accordance with ESC theory.

An amplitude of the oscillation may be chosen to result in a given initial CTHDi, but this depends on many factors such as an initial error from the PLL 518, system delays, a load, values of circuit parameters, etc.

Further, a frequency of the oscillation may be chosen to be less than a nominal frequency of the power grid (i.e., subsynchronous). For example, the chosen frequency may be chosen to be smaller than 10 Hz, such as 5 Hz, which is much less than the nominal frequency of 50 Hz of the power grid. The frequency of the oscillation is a tuning parameter which should be smaller than the inverse of the system time-constant but higher than the inverse of the settling time constant.

The perturbation/oscillation frequency controls time scale separation of an estimation process of the phase correction angle 526 and the estimation process of the gradient performed by the inclusion of the perturbation/oscillation. Thereby, a—faster—regulation by the closed-loop current control 50 and a—slower—regulation by ESC do not interfere with each other owing to operation on different time scales/time constants. Thus, a slow but highly effective phase angle correction is achieved, which decouples the zero-crossing distortion compensation from the main control loops (e.g., power and current control). This also simplifies a development of control, which is of particular relevance when considering multi-module implementations.

In line with ESC theory, an example of how to generate the phase correction angle 526 from the CTHDi 530 can be defined in the z-domain as follows.

First, a digital high-pass filter H₁(z) having a cut-off frequency ωₕ is applied to the CTHDi(kTₛ) signal, with k=0, 1, . . . being a sample number and Tₛ being a control sampling period, respectively, giving rise to a variable called u₁(kTₛ). An appropriate choice of the cut-off frequency ωh ensures that a DC component of the CTHDi 530 is rejected.

The variable u₁(kTₛ) is multiplied by the above-mentioned subsynchronous oscillation/perturbation a sin(ωkTₛ+φₒ) having a constant gain a, the oscillation frequency ω>ωₕ and an arbitrary constant phase angle φₒ, giving rise to a variable u₂(kTₛ). The gain a is a design parameter: a large gain increases speed of convergence and a residual error at the extremum, and a small gain increases the probability of getting stuck at a local extremum but decreases the residual error.

A digital integration filter H₂(z) is applied to the variable u₂(kTₛ), giving rise to u₃(kTₛ).

The modulating function K sin(ωₒkTₛ+φₒ) is added to the variable u₃(kTₛ), giving rise to the phase correction angle 526, at each sampling time.

ESC operation subsequently attempts to minimize the CTHDi 530, and at the same time the phase correction angle 526, to minimal values. During a transient time both the CTHDi 530 and the phase correction angle 526 show the above-mentioned oscillation below the nominal frequency of the power grid. This oscillation disappears from the CTHDi 530 when a steady-state is reached and is minimized for the phase correction angle 526. Some steady-state self-sustained oscillation remains in the phase correction angle 526. In summary, this behaviour proves the cause-effect, i.e., deterministic relation, between the system input and system output of the ESC-controlled system.

Consequently, the UPFC 10 may be configured to establish the phase angle 514 of the reference variable 504 by adding up the phase angle 524 of the fundamental frequency component of the input voltage and the phase correction angle 526 determined in dependence of the amplitudes Iₙ of the frequency components. According to FIG. 5, this correction may be accomplished within the PLL 518, for example, which typically comprises a voltage-controlled oscillator, VCO.

Thereby, the target/reference phase angle 514 also takes into account the harmonic frequency components of the input current 502 besides the fundamental frequency component of the input voltage, by means of a simple implementation.

The UPFC 10 may further be configured to manipulate a PWM drive signal for an active power electronic switching device of the UPFC 10. More specifically, a control error is formed at the input of the controller 506 by subtracting the process variable (actual/measured current) 502 from the reference variable (reference current) 504, and the control error is turned into a manipulated variable 508, which may be a duty cycle 208 of a PWM drive signal for active power electronic switches (e.g., IGBTs or MOSFETs) of the UPFC 10. The active power electronic switches thus are part of the current control process 510, which continuously yields the process variable (actual current) 502 produced in accordance with the manipulated variable (duty cycle) 508 to further minimize the control error.

Thereby, the power electronic switches of the UPFC 10 may realize a response to the corrected phase angle 514 of the reference variable without requiring further modifications of their drive arrangement.

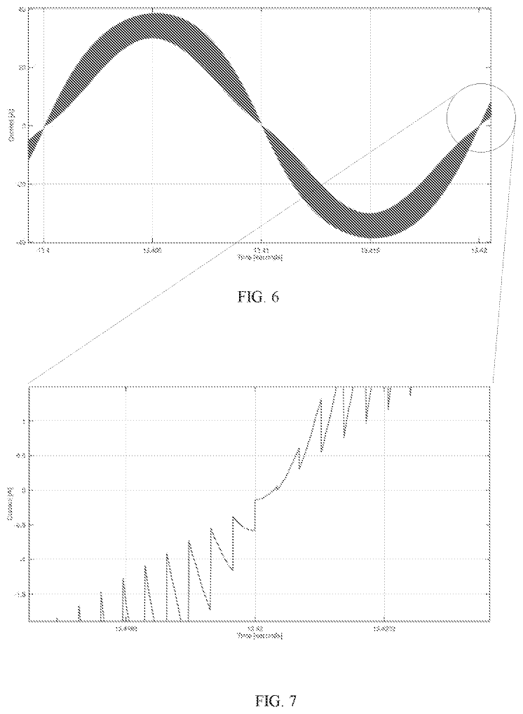

FIGS. 6, 7 illustrate an improvement of the closed-loop control 50 of FIG. 5 over the exemplary solution shown in FIGS. 2-4.

Every load change causes the closed-loop control 50 to undergo a transient phase in which both the CTHDi 530 and the phase correction angle 526 show the above-mentioned oscillation below the nominal frequency of the power grid. This oscillation disappears from the CTHDi 530 when a steady-state is reached and is minimized for the phase correction angle 526. After the transient phase, stationary constant values for the CTHDi 530 and the phase correction angle 526 are obtained.

FIG. 6 shows a current waveform of a rectifier module 10 having a unidirectional topology, wherein the current waveform is regulated by the closed-loop control 50 after decay of the transient phase. The horizontal and vertical axes of FIG. 6 denote time in seconds and current in amperes, respectively.

With respect to the closed-loop control 20 of FIG. 2, the phase angle detection is significantly improved as explained in connection with FIG. 5, so that the voltage and current waveforms do not significantly diverge and the current zero-crossings are substantially linear.

FIG. 7 shows a zoom of a current zero-crossing of the current waveform of FIG. 6 around a voltage zero-crossing at time instant 13,42 s. The figure depicts a continuous conduction mode (CCM) operation in a vicinity of the voltage zero-crossing, as voltage and current work with substantially the same sign, in accordance with the strong physical constraint of the system.

This effect is reflected as a decrease in current distortion and, in turn, in a corresponding increase in power factor.

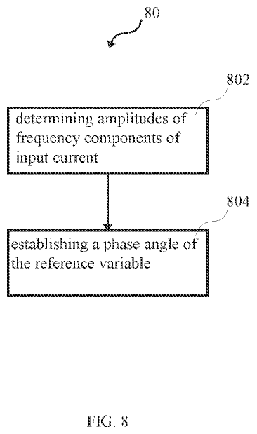

FIG. 8 illustrates a method 80 of operating a unity power factor rectifier, UPFC 10, according to an embodiment of the first aspect.

The UPFC 10 is connectable to a power grid and comprises a closed-loop control 50 for regulation of an input current 502 from the power grid in accordance with a reference variable 504 for the input current 502.

The method 80 comprises a step of determining 802 amplitudes of frequency components of the input current 502.

The method 80 further comprises a step of establishing 804 a phase angle 514 of the reference variable 504 in dependence of a phase angle 524 of a fundamental frequency component of an input voltage from the power grid and of the amplitudes of the frequency components.

The method 80 may be performed by the UPFC 10 according to the first aspect or any of its embodiments.

Thereby, the advantages mentioned in connection with the various embodiments of the UPFC 10 of the first aspect apply similarly to the corresponding embodiments of the method 80 according to the second aspect.

A computer program (not shown) comprises a program code for carrying out the method 80 according to the second aspect or any of its embodiments when implemented on a processor (or processing circuitry) of the UPFC 10.

The processor or processing circuitry of the UPFC 10 may comprise hardware and/or the processing circuitry may be controlled by software. The hardware may comprise analog circuitry or digital circuitry, or both analog and digital circuitry. The digital circuitry may comprise components such as application-specific integrated circuits (ASICs), field-programmable gate arrays (FPGAs), digital signal processors (DSPs), or multi-purpose processors.

The UPFC 10 may further comprise memory circuitry, which stores one or more instruction(s) that can be executed by the processor or by the processing circuitry, in particular under control of the software. For instance, the memory circuitry may comprise a non-transitory storage medium (not shown) storing executable program code which, when executed by the processor or the processing circuitry, causes the method 80 according to the second aspect or any of its embodiments to be performed.

The present invention has been described in conjunction with various embodiments as examples as well as implementations. However, other variations can be understood and effected by those persons skilled in the art and practicing the claimed invention, from the studies of the drawings, this disclosure and the independent claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

1. A unity power factor converter (UPFC) connectable to a power grid, the UPFC comprising a closed-loop control for regulation of an input current from the power grid in accordance with a reference variable for the input current, wherein the UPFC is configured to:
determine amplitudes of frequency components of the input current; and
establish a phase angle of the reference variable in dependence of a phase angle of a fundamental frequency component of an input voltage from the power grid and in dependence of the amplitudes of the frequency components.

2. The UPFC of claim 1, wherein the UPFC is configured to establish an amplitude of the reference variable in dependence of an outer closed-loop control of the UPFC.

3. The UPFC of claim 1, wherein the UPFC is configured to establish the phase angle of the fundamental frequency component of the input voltage by a phase locked loop (PLL) of the UPFC when the PLL is locked onto the fundamental frequency component of the input voltage.

4. The UPFC of claim 1, wherein the UPFC is configured to establish the phase angle 4) of the reference variable by adding up the phase angle of the fundamental frequency component of the input voltage and a phase correction angle determined in dependence of the amplitudes of the frequency components.

5. The UPFC of claim 4, wherein the UPFC is configured to determine the phase correction angle in dependence of a custom total harmonic distortion (CTHDi) of the input current, wherein the CTHDi of the input current is determined as a rational function in dependence of the amplitudes of the frequency components.

6. The UPFC of claim 5, wherein the UPFC is configured to determine the phase correction angle by means of Extremum Seeking Control (ESC).

7. The UPFC of claim 5, wherein the CTHDi comprises an oscillation.

8. The UPFC of claim 7, wherein a frequency of the oscillation is less than a nominal frequency of the power grid.

9. The UPFC of claim 1, wherein the UPFC is configured to determine the amplitudes of the frequency components by at least one of a discrete Fourier transform or a fast Fourier transform (FFT).

10. The UPFC of claim 9, wherein the UPFC is configured to determine the amplitudes of the frequency components in real-time.

11. The UPFC of claim 9, wherein the amplitudes of the frequency components comprise real-time Fourier coefficients, squared real-time Fourier coefficients, or a weighted rational combination of the real-time Fourier coefficients of the input current.

12. The UPFC of claim 1, wherein the UPFC is configured to manipulate a pulse-width modulation (PWM) drive signal for an active power electronic switching device of the UPFC.

13. A method of operating a unity power factor rectifier (UPFC) connectable to a power grid, the UPFC comprising a closed-loop control for regulation of an input current from the power grid in accordance with a reference variable for the input current, wherein the method comprises:
determining amplitudes of frequency components of the input current; and
establishing a phase angle of the reference variable in dependence of a phase angle of a fundamental frequency component of an input voltage from the power grid and in dependence of the amplitudes of the frequency components.

14. The method of claim 13, wherein the method is performed by the UPFC.

15. A non-transitory computer readable storage medium, wherein the non-transitory computer readable storage medium stores programming instructions for execution by at least one processor of a unity power factor converter (UPFC) to:
determine amplitudes of frequency components of an input current from a power grid in accordance with a reference variable for the input current; and
establish a phase angle of the reference variable in dependence of a phase angle of a fundamental frequency component of an input voltage from the power grid and in dependence of the amplitudes of the frequency components.

16. The non-transitory computer readable storage medium of claim 15, wherein the non-transitory computer readable storage medium stores the programming instructions for execution by the at least one processor to:
establish an amplitude of the reference variable in dependence of an outer closed-loop control of the UPFC.

17. The non-transitory computer readable storage medium of claim 15, wherein the non-transitory computer readable storage medium stores the programming instructions for execution by the at least one processor to:
establish the phase angle of the fundamental frequency component of the input voltage by a phase locked loop (PLL) of the UPFC when the PLL is locked onto the fundamental frequency component of the input voltage.

18. The non-transitory computer readable storage medium of claim 15, wherein the non-transitory computer readable storage medium stores the programming instructions for execution by the at least one processor to:
establish the phase angle of the reference variable by adding up the phase angle of the fundamental frequency component of the input voltage and a phase correction angle determined in dependence of the amplitudes of the frequency components.

19. The non-transitory computer readable storage medium of claim 18, wherein the non-transitory computer readable storage medium stores the programming instructions for execution by the at least one processor to:
determine the phase correction angle in dependence of a custom total harmonic distortion (CTHDi) of the input current, wherein the CTHDi of the input current is determined as a rational function in dependence of the amplitudes of the frequency components.

20. The non-transitory computer readable storage medium of claim 19, wherein the non-transitory computer readable storage medium stores the programming instructions for execution by the at least one processor to:
determine the phase correction angle by means of Extremum Seeking Control (ESC).
